(19) United States
(12) Patent Application Publication
(10) Pub. No.: US 2005/0044105 A1
(43) Pub. Date: Feb. 24, 2005

(54) System and method for delivery of content-specific video clips

(75) Inventor: Londrew Glenn Terrell, Arlington, TX (US)

Correspondence Address: DOCKET CLERK, P.O. DRAWER 800889, DALLAS, TX, 75380, US

(73) Assignee: Kelly Glenn Terrell, Arlington, TX (US)

(21) Appl. No.: 10/643,426

(22) Filed: Aug. 19, 2003

(51) Int. Cl. G06F 17/00

(52) U.S. Cl. 707/104.1

(57) ABSTRACT

A system and method for delivery of content-specific video clips. A database is maintained which stores multiple video “clips” or segments in video data files, extracted from full-length films and videos, including feature films. Each of the clips is associated with multiple keywords, including keywords related to the concepts presented or illustrated by the clip. This database can be searched online, and selected clips can be delivered as streaming video for review, and can be delivered as a video data file for including in a presentation, along with a license to do so.

### TECHNICAL FIELD OF THE INVENTION

The present invention is directed, in general, to online video clip delivery.

### BACKGROUND OF THE INVENTION

As technology becomes more prevalent in all aspects of society, various audiences are expecting more sophisticated multimedia presentations, whether in class, at a business presentation, or in a church sermon.

More sophisticated presentations are now generally created using a software package such as Microsoft's “PowerPoint”, “MediaShout”, or others which allow graphics and text to be projected on a display, often accompanied by sound. Increasingly, full-motion multimedia content is included in this presentations, such as a video clip displayed either full-screen or in a window of the presentation display.

Less sophisticated presentations require the presenter to “cue up” a videotape or DVD to the exact frame he wishes to begin his presentation, and then use push and play technique by means of a secondary projection system, and then stopping the scene at the frame chosen. This older means of video display is much more cumbersome, frequently requiring assistance from another person.

While these multimedia presentations are more engaging and enjoyable for the audience, they are much more trouble to create that just simply delivering a speech. As the quality and quantity of the multimedia content increases, so does the difficulty and time needed to create these presentations.

One particularly difficult part of this creation process is finding an appropriate video segment to be included with the presentation. To be most effective, the clip must be relevant to the subject, short enough as to keep the audience attention, and preferably recognizable by the audience as part of a familiar film or movie.

Currently, there is no easy way to find appropriate video content. To include video in a presentation, the preparer must generally already know of a relevant portion of, for example, a movie. He must then find the movie on videotape or DVD (or other manipulable form). Then, he must extract the relevant portion from the film into a video data file. Finally, he must insert the video data file, or a link to it, into his presentation.

This process commonly takes an impractical amount of time. Further, if the preparer is not already aware of some portion of a movie or other video that captures the point to be made, the preparer has no way of finding a relevant video clip in the first place.

There is, therefore, a need in the art for a system and method for identifying and easily capturing relevant video segments for use in presentations and otherwise.

### SUMMARY OF THE INVENTION

The preferred embodiment provides a system and method for delivery of content-specific video clips. A database is maintained which stores multiple video “clips” or segments in video data files, extracted from full-length films and videos, including feature films. Each of the clips is associated with multiple keywords, including keywords related to the concepts presented or illustrated by the clip. This database can be searched online, and selected clips can be delivered as streaming video for review, and can be delivered as a video data file for including in a presentation, along with a license to do so.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIG. 2 depicts a data processing system in which a preferred embodiment of the present invention may be implemented, as any of the disclosed data processing systems;

FIG. 3 depicts a flowchart of a process in accordance with a preferred embodiment.

### DETAILED DESCRIPTION OF THE INVENTION

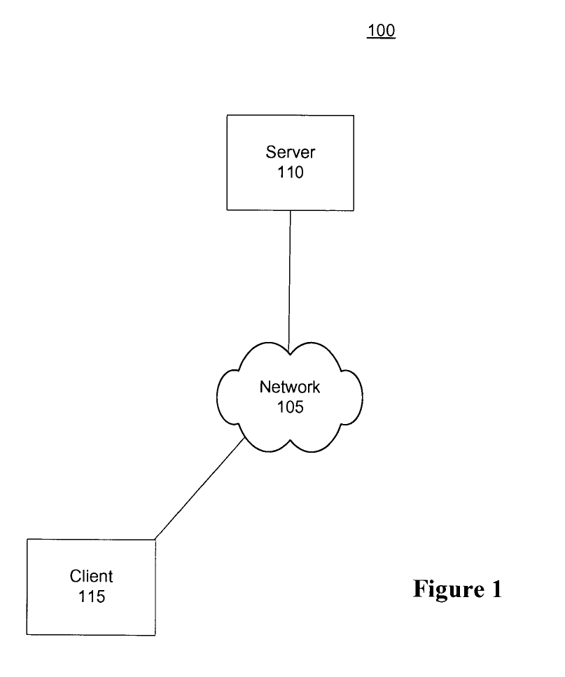

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The preferred embodiment provides a system and method for delivery of content-specific video clips. A database is maintained which stores multiple video “clips” or segments in video data files, extracted from full-length films and videos, including feature films. Each of the clips is associated with multiple keywords, including keywords related to the concepts presented or illustrated by the clip. This database can be searched online, and selected clips can be delivered as streaming video for review, and can be delivered as a video data file for including in a presentation, along with a license to do so.

The term “keyword” as used herein refers to terms associated with video clips or files, by which the clips can be searched, indexed, or identified. The term “search term” or “search phrase” indicates the term or phase used to search for a particular clip, and the search terms are matched against the keywords. Those of skill in the art will recognize that in many contexts, then, these phrases are used interchangeably to indicate a term or phrase that is both a search term and a keyword.

FIG. 1 depicts a block diagram of a data processing system in which a preferred embodiment can be implemented. Network system 100 can be implemented in any type of public or private computer network, and can be implemented by data processing systems connected by telephone line, a local-area-network, a wide-area-network, by Ethernet, fiber optic cable, or any other known means.

Server 110 is connected to network system 105, and can thereby communicate with client system 115.

Typically, a user will use client system 115 to access a servlet and data on server 110. The user will typically use a thin-client browser on client system 115 to access server 110. It should be noted that typically many other data processing systems will be connected to network system 105, including multiple client systems and multiple server systems.

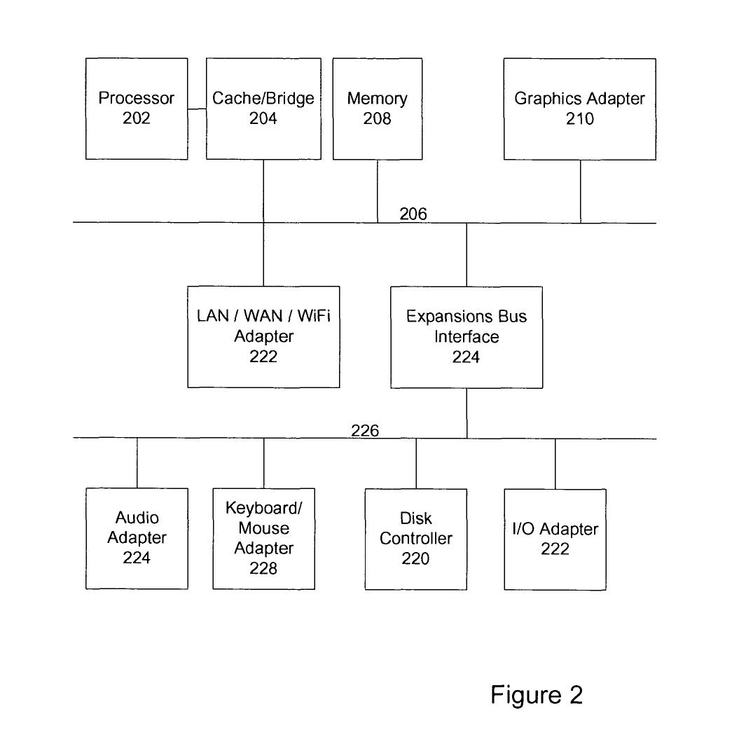

FIG. 2 depicts a data processing system in which a preferred embodiment of the present invention may be implemented, as any of the disclosed data processing systems. The data processing system depicted includes a processor 202 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210.

Other peripherals, such as local area network (LAN)/Wide Area Network/Wireless (e.g. WiFi) adapter 212, may also be connected to local system bus 206. Expansion bus interface 214 connects local system bus 206 to input/output (I/O) bus 216. I/O bus 416 is connected to keyboard/mouse adapter 218, disk controller 220, and I/O adapter 222.

Also connected to I/O bus 216 in the example shown is audio adapter 224, to which speakers (not shown) may be connected for playing sounds. Keyboard/mouse adapter 418 provides a connection for a pointing device (not shown), such as a mouse, trackball, trackpointer, etc.

Those of ordinary skill in the art will appreciate that the hardware depicted in FIG. 2 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface can be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described. Further, a spreadsheet application such as Microsoft Excel™ can be used to implement certain aspects of the present invention.

In the preferred embodiment, a server system is provided that stores a large collection of video clips in a data storage such as a hard disk drive, dvd-rom drive, or other known optical or magnetic media. The video clips are stored in a computer-readable form, such as an MPEG file, AVI file, or other known computer-readable audio/video formats, which will be generically called herein a “video file.” These video clips are accessible by the server system, and can be transmitted by the server system to a client system either as a “streaming” video, or simply by sending the entire video file, or both. Note that the video files may be stored on the server itself, or may be stored in separate storage that is accessible by the server.

Each video file is a “clip” or video segment from a film or video. Preferably, each clip is chosen so that it illustrates a single concept or principle, but of course, the clips can be chosen according to any desired criteria. The films and videos from which the clips are taken can include feature films, music videos, special interest videos, promotional or educational videos, custom and home videos, and any other type of video or film. It should be noted that while these clips are referred to as “video clips,” these clips will also typically include as associated audio track and other imbedded information.

On the server system, there is also a database containing searchable data related to each of the video files. The searchable data includes many terms related to each video file, including but not limited to a movie or film name, the names of actors, directors, producers, screenwriters, production companies, studios, film characters, and any other persons appearing in the clip, the text of any dialog spoken in the clip, the titles or composers of any music playing in the clip, and other information typically associated with films and videos.

Further, various embodiments provide that the searchable data also includes keywords related to the concepts, ideas, lessons, implied messages, educational values, and educational impacts of each clip, even when these terms are not explicitly used in the clip dialog. For example, if a clip shows a scene where a father and son are discussing the consequences of lying, the clip can also be associated with keywords such as “lie(s)”, “truthfulness”, “deceit”, “honesty”, “discipline”, and others. Specific examples include:

The scene from the movie “Rainman” when Dustin Hoffman's character is counting the toothpicks on the floor can have ‘math’ as an associated keyword;

A dance scene in the movie “Jungle Book” can include the word ‘rhythm’ as one of the keywords; and

Many scenes from the movie “Pay It Forward” are can be associated with the keywords “Social Behavior”.

These additional keyword types are particularly valuable for those preparing presentations, as they make it possible to search for relevant, illustrative video clips without having a pre-existing knowledge that the clip exists. For example, one preparing a speech, lecture, or sermon on “honesty” can search on that term, and the server will return a list of clips that either specifically include the term “honesty” in the dialog, and also clips that are related to the concept of honesty. In this way, the user can quickly locate and review relevant clips, without having to search blindly or simply rely on her pre-exiting knowledge of various movies.

In addition, the keywords for each clip can include references to conceptually related verses from the Bible or other religious texts. For example, searching on the keyword “John 3:16” (“For God so loved the world that He gave his only begotten Son, that whoever believes in Him shall not perish but have eternal life.”) would return clips related to salvation, love, sacrifice, and faith, among others. This can be implemented in several ways, including specifically listing each relevant Bible verse with each clip, or by creating a cross-reference between Bible verses and relevant concepts, then searching the clip database for those concepts. This feature is particularly helpful for preparing sermons, Bible studies, and Sunday School presentations.

Keywords for the database can be automatically harvested from other movie databases and sources, and can be manually entered by the server operator and others. Optionally, the users can be allowed to add additional keywords to clips in the database.

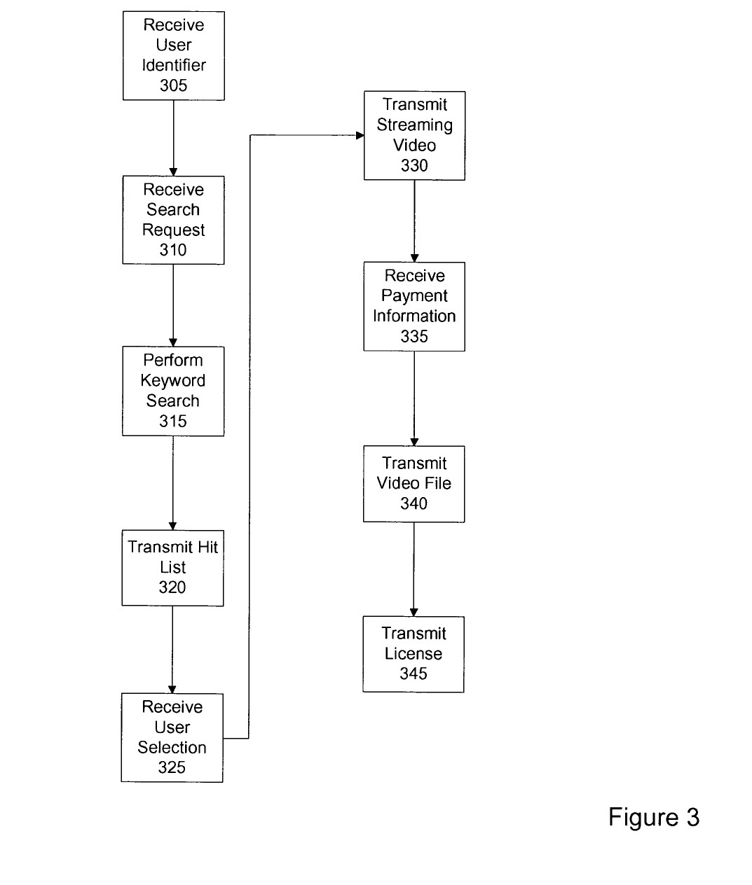

FIG. 3 depicts a flowchart of a process in accordance with the preferred embodiment. Here, the server system receives a user identifier from a client system (step 305). The server receives a search request from the client system comprising one or more keywords (step 310). The server performs a keyword search to identify one or more matching video clips (step 315). The “hit list” of matching video clips is transmitted to the client system (step 320).

The server receives a user selection (step 325). Optionally, the server will transmit a copy-protected streaming video of the selected video clip to the client system (step 330). The server will optionally receive payment information (step 335).

Finally, the server will transmit a copy of the video file for the selected clip to the client (step 340). The transmitted video file is in a format that can be incorporated into a presentation. The server also transmits a license for the user to actually use the clip in a presentation (step 345).

According to another embodiment, when the license has been transmitted, the server then will store an entry regarding the download/purchase of the video clip license. The system will then use this entry as part of a process to make royalty payments to the owners of the original clip, according to a corresponding license arrangement.

An additional feature is for use in searching for video clips to illustrate biblical or religious presentations. In this case, at the user's option, the server will translate one or more of the user's search terms into the original scriptural language, and perform the keyword search using the translated word. In this case, the keyword database will also include keywords in these other languages. In this manner, where an English word may have several different meanings, the context of the original text is retained.

Those of skill in the art will recognize that the steps above are not necessarily performed in the order recited. For example, the receipt of the user identifier, the receipt of the payment information, and the transmittal of the license can take place at any point during the process, or indeed, at an earlier or later time than the rest of the process. In one particular variation, the license to use the video clip is encoded with the video clip and is sent simultaneously.

In another embodiment, the system can accept a client request for a custom video clip, if it is not already found in the database. In this case, the requested clip is be extracted from the full video in which it appears, converted to a video file format, and sent to the client along with a license to use the clip in a presentation. The client is charged accordingly.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 200 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for distributing video clips, comprising:
receiving a search request including at least one search term;
identifying at least one video clip corresponding to the search term;
transmitting the video clip in a streaming-video format; and
transmitting the video clip in a video-file format, wherein the video clip is a portion of a longer video.

2. The method of claim 1, further comprising transmitting a license to display the video clip in a presentation.

3. The method of claim 1, further comprising transmitting a list of video clips corresponding to the search term.

4. The method of claim 1, further comprising receiving payment information.

5. The method of claim 1, wherein the search term identifies the subject-matter content of a video clip.

6. The method of claim 1, wherein the search term identifies a concept illustrated by the video clip.

7. The method of claim 1, wherein the search term is a reference to at least one Bible verse, and the video clip illustrates the concept addressed by the Bible verse.

8. A computer program product tangibly embodied in a computer-readable medium, comprising:
instructions for receiving a search request including at least one search term;
instructions for identifying at least one video clip corresponding to the search term;
instructions for transmitting the video clip in a streaming-video format; and
instructions for transmitting the video clip in a video-file format, wherein the video clip is a portion of a longer video.

9. The computer program product of claim 8, further comprising instructions for transmitting a license to display the video clip in a presentation.

10. The computer program product of claim 8, further comprising instructions for transmitting a list of video clips corresponding to the search term.

11. The computer program product of claim 8, further comprising instructions for receiving payment information.

12. The computer program product of claim 8, wherein the search term identifies the subject-matter content of a video clip.

13. The computer program product of claim 8, wherein the search term identifies a concept illustrated by the video clip.

14. The computer program product of claim 8, wherein the search term is a reference to at least one Bible verse, and the video clip illustrates the concept addressed by the Bible verse.

15. A data processing system having at least a processor and accessible memory, comprising:
means for receiving a search request including at least one search term;
means for identifying at least one video clip corresponding to the search term;
means for transmitting the video clip in a streaming-video format; and
means for transmitting the video clip in a video-file format, wherein the video clip is a portion of a longer video.

16. The data processing system of claim 15, further comprising means for transmitting a license to display the video clip in a presentation.

17. The data processing system of claim 15, further comprising means for transmitting a list of video clips corresponding to the search term.

18. The data processing system of claim 15, further comprising means for receiving payment information.

19. The data processing system of claim 15, wherein the search term identifies the subject-matter content of a video clip.

20. The data processing system of claim 15, wherein the search term identifies a concept illustrated by the video clip.

21. The data processing system of claim 15, wherein the search term is a reference to at least one Bible verse, and the video clip illustrates the concept addressed by the Bible verse.

22. A data processing system having at least a processor and accessible memory, comprising:
a data storage device storing a plurality of video files, each video file being stored in a format that can be transmitted over a data processing system network, and each video file being a digitally-encoded audio-video clip; and
a database storing keywordss associated with the video files, wherein at least one of the video files is associated with at least one keyword, and wherein at least one keyword identifies the subject-matter content of the audio-video clip.
